(19) United States
(12) Patent Application Publication
(10) Pub. No.: US 2015/0197970 A1
(43) Pub. Date: Jul. 16, 2015

(54) ELASTICALLY AVERAGED ASSEMBLY FOR CLOSURE APPLICATIONS

(71) Applicant: GM GLOBAL TECHNOLOGY OPERATIONS LLC, Detroit, MI (US)

(72) Inventors: Steven E. Morris, Fair Haven, MI (US); Jeffrey A. Abell, Rochester Hills, MI (US); Jennifer P. Lawall, Waterford, MI (US); Jeffrey L. Konchan, Romeo, MI (US)

(73) Assignee: GM GLOBAL TECHNOLOGY OPERATIONS LLC, Detroit, MI (US)

(21) Appl. No.: 14/153,741

(22) Filed: Jan. 13, 2014

(51) Int. Cl. E05C 19/00; B60J 7/19; B60J 7/185

(52) U.S. Cl. CPC E05C 19/007; B60J 7/1851; B60J 7/194

(57) ABSTRACT

An elastically averaged assembly for closure applications includes a first component comprising at least one receiving feature. Also included is a second component to be repeatedly mated with the first component, the second component comprising at least one protrusion, the at least one receiving feature configured to fittingly receive the at least one protrusion, wherein the at least one protrusion is configured to be repeatedly removed from the at least one receiving feature. The at least one protrusion is formed of an elastically deformable material configured to elastically deform upon contact with the at least one receiving feature.

### FIELD OF THE INVENTION

The invention relates to closure applications, and more particularly to an elastically deformable, elastically averaged assembly for closure applications.

### BACKGROUND

Closure applications include components which are to be repeatedly engaged with each other and removed from each other. Doors are just one example of such an application that requires repeatable engagement. Various latches are employed to facilitate engagement. Unfortunately, latches often lead to looseness in the engagement even when a door or another closure application is positively latched. The latches are subject to positional variation and may result in undesirable noises that are unappealing to a consumer, such as buzzing, squeaking, and rattling, for example. Accordingly, components that facilitate robust closing of the components, while eliminating undesirable relative movement is desired.

### SUMMARY OF THE INVENTION

In one exemplary embodiment, a elastically averaged assembly for closure applications includes a first component comprising at least one receiving feature. Also included is a second component to be repeatedly mated with the first component, the second component comprising at least one protrusion, the at least one receiving feature configured to fittingly receive the at least one protrusion, wherein the at least one protrusion is configured to be repeatedly removed from the at least one receiving feature. The at least one protrusion is formed of an elastically deformable material configured to elastically deform upon contact with the at least one receiving feature.

In another exemplary embodiment, an elastically averaged assembly for closure applications includes a mating panel having a receiving feature. Also included is a closure panel pivotally connected to the mating panel, the closure panel having a protrusion configured to repeatedly engage, and be repeatedly removed from, the receiving feature to provide a closure condition between the mating panel and the closure panel. The protrusion is formed of an elastically deformable material configured to elastically deform upon contact with the receiving feature.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic illustration of an elastically averaged assembly according to a first embodiment;

FIG. 2 is a schematic illustration of an engagement region of the elastically averaged assembly of FIG. 1 in a pre-engaged position;

FIG. 3 is a schematic illustration of the engagement region of the elastically averaged assembly of FIG. 1 in a partially engaged position;

FIG. 4 is a schematic illustration of the engagement region of the elastically averaged assembly of FIG. 1 in a fully engaged position;

FIG. 5 is a schematic illustration of a elastically averaged assembly according to a second embodiment; and

FIG. 6 is a schematic illustration of an exemplary receiving feature pattern of the elastically averaged assembly.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

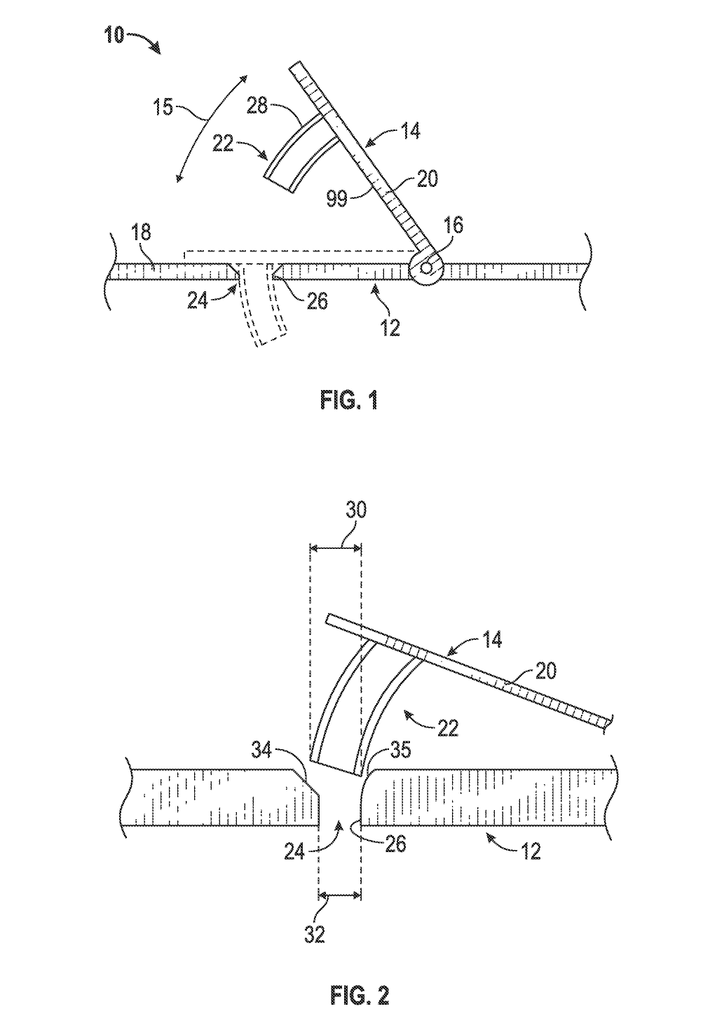

Referring to FIG. 1, an elastically averaged assembly 10 is illustrated according to a first embodiment. The elastically averaged assembly 10 comprises matable components, such as a first component 12 and a second component 14 that are configured to be mated and aligned with respect to each other. In one embodiment, the elastically averaged assembly 10 is employed in a vehicle application. However, it is to be understood that the components may be associated with numerous other applications and industries, such as home appliance and aerospace applications, for example. In particular, the elastically averaged assembly 10 is employed as a closure arrangement for closure applications. As such, the first component 12 may also be referred to herein as a “mating panel,” while the second component 14 may also be referred to herein as a “closure panel.”

Although illustrated in a specific geometry, the first component 12 and the second component 14 may be configured in countless geometries. Regardless of the precise geometry of the first component 12 and the second component 14, the second component 14 is pivotally coupled to the first component 12 at a pivot location 16. The pivotal connection may be made with any suitable connection structure that will depend on the particular application. Such a connection may include a living hinge, slot and tab, or tongue-and-groove arrangement, for example, although numerous others are contemplated. The second component 14 is configured to align and fittingly mate with the first component 12, which will be described in detail below. It is to be appreciated that the elastically averaged assembly 10 is to be employed for providing a self-aligning relationship between components, such as the first component 12 and the second component 14, while also assisting in securely mating and retaining the components to each other. Furthermore, the second component 14 is configured to be repeatedly engaged with, and repeatedly removed from, the first component 12.

Numerous specific applications are contemplated for use with an embodiment of the elastically averaged assembly 10. In particular, any hinged or pivotal component that is required to engage another component and “close out” a space would benefit from the elastically averaged assembly 10. Examples of such arrangements include any hinged door, such as a compartment lid, fuse box door, fastener access cover, ash tray closure, cup holder door, convertible top closure, or under hood compartments such as the air filter lid. The preceding list is merely illustrative and is not intended to be exhaustive of potential doors or hinged components that may be employed.

The first component 12 includes a main portion 18, which may define a space to be closed or sealed by the second component 14 upon engagement with the first component 12. The second component 14 also includes a main portion 20 and a protrusion 22 extending from the main portion 20. The protrusion 22 is formed of an elastically deformable material, as will be described in detail below. The protrusion 22 is operatively coupled to the main portion 20 and may be integrally formed with the main portion 20. The protrusion 22 may be disposed in numerous contemplated orientations relative to the main portion 20 of the second component 14 and may be formed in various geometries. In one embodiment, the protrusion 22 is a relatively straight member. In such an embodiment, the protrusion 22 may be disposed in a direction relatively orthogonal from a plane that the main portion 20 is disposed in or at an angle thereto (i.e., non-perpendicular). In another embodiment, the protrusion 22 is an arcuate member, wherein all or a portion of the protrusion 22 has a region of curvature.

The first component 12 includes a receiving feature 24 that is formed in the main portion 18 in the manner of an opening, a slot or the like. The receiving feature 24 is configured to engage and receive the protrusion 22 upon mating of the first component 12 and the second component 14. Although a single elastically deformable protrusion and a single receiving feature are referenced, embodiments of the elastically averaged assembly 10 may include a plurality of elastically deformable protrusions and a plurality of receiving features, as will be described in detail below. Additionally, the protrusion(s) 22 and the receiving feature(s) 24 may be positioned in numerous locations on the second component 14 and the first component 12, respectively. In the illustrated embodiment, the protrusion 22 is disposed proximate an edge 99 of the second component 14, but it is to be appreciated that the protrusion(s) may be located along one or more alternative edges or at interior locations of the second component 14.

It is contemplated that the protrusion 22 and the receiving feature 24 may include numerous embodiments. In particular, the protrusion 22 may be formed as a relatively cylindrical member that is either solid or hollow (i.e., tubular), spherical, triangular, teardrop-shaped, or a pin with head and neck portions, etc. The preceding list is merely exemplary and it is to be understood that any suitable geometry that is formed of an elastically deformable material may be employed. The particular geometry of a receiving feature 24 may also vary, but is configured to fittingly receive and retain a protrusion 22 upon attaining a contact interference condition between a receiving feature wall 26, that defines the receiving feature 24, and at least a portion of a protrusion surface 28. Additionally, as noted above, the protrusion 22 facilitates retention in this condition, yet is still repeatedly removable from the receiving feature 24.

As will be apparent from the description herein, the elastically deformable nature of the protrusion(s), in combination with the particular orientations described, facilitates precise alignment of the first component 12 relative to the second component 14 by accounting for positional variation of the retaining and/or locating features of the components that are inherently present due to manufacturing processes. The self-aligning benefits associated with the elastically averaged assembly 10 will be described in detail below.

The protrusion 22 of the second component 14 is positioned to engage with the receiving feature 24 of the first component 12 upon pivoting of the second component 14 toward the first component 12 along path 15. As such, the second component 14 is inserted into the first component 12 upon engagement of the protrusion 22 with the receiving feature 24. More particularly, the protrusion surface 28 engages the receiving feature wall 26. Subsequent translation or pivoting results in an elastic deformation of the protrusion 22. The protrusion 22 includes a protrusion dimension 30, FIG. 2, (e.g., width, diameter, etc.) that is greater than a receiving feature dimension 32 (e.g., width, diameter, etc.), thereby ensuring contact between the protrusion 22 and the receiving feature 24.

Any suitable elastically deformable material may be used to construct the protrusion 22. The term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Numerous examples of materials that may at least partially form the components include various metals, polymers, ceramics, inorganic materials or glasses, or composites of any of the aforementioned materials, or any other combinations thereof. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. An example of a suitable polymer includes acetal (e.g., POM). In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS), such as an ABS acrylic. The material may be in any form and formed or manufactured by any suitable process, including stamped or formed metal, composite or other sheets, forgings, extruded parts, pressed parts, castings, or molded parts and the like, to include the deformable features described herein. The material, or materials, may be selected to provide a predetermined elastic response characteristic of the protrusion 22. The predetermined elastic response characteristic may include, for example, a predetermined elastic modulus and/or coefficient of friction.

The precise position where engagement between the protrusion surface 28 and the receiving feature wall 26 occurs will vary depending on positional variance imposed by manufacturing factors. Due to the elastically deformable properties of the elastic material comprising the protrusion 22, the criticality of the initial location of engagement is reduced. Further continued insertion of the protrusion 22 into the receiving feature 24 ultimately leads to a fully engaged position of the protrusion 22. In the fully engaged position, a tight, fitted engagement between the protrusion 22 and the receiving feature 24 is achieved by contact interference between the protrusion surface 28 and the receiving feature wall 26. Such a condition is ensured by sizing the protrusion dimension 30 to be larger than the receiving feature dimension 32, as described above. The interference between the protrusion 22 and the receiving feature wall 26 causes elastic deformation proximate the protrusion surface 28. The malleability of the materials reduces issues associated with positional variance. More particularly, in contrast to a rigid insert that typically results in gaps between the insert and receiving structure at portions around the perimeter of the insert, the protrusion 22 advantageously deforms to maintain alignment of the first component 12 and the second component 14, while also reducing or eliminating gaps associated with manufacturing challenges. The assembly also advantageously reduces the number of mechanical fasteners, such as threaded fasteners required for attachment of the components, thereby reducing cost and component degradation.

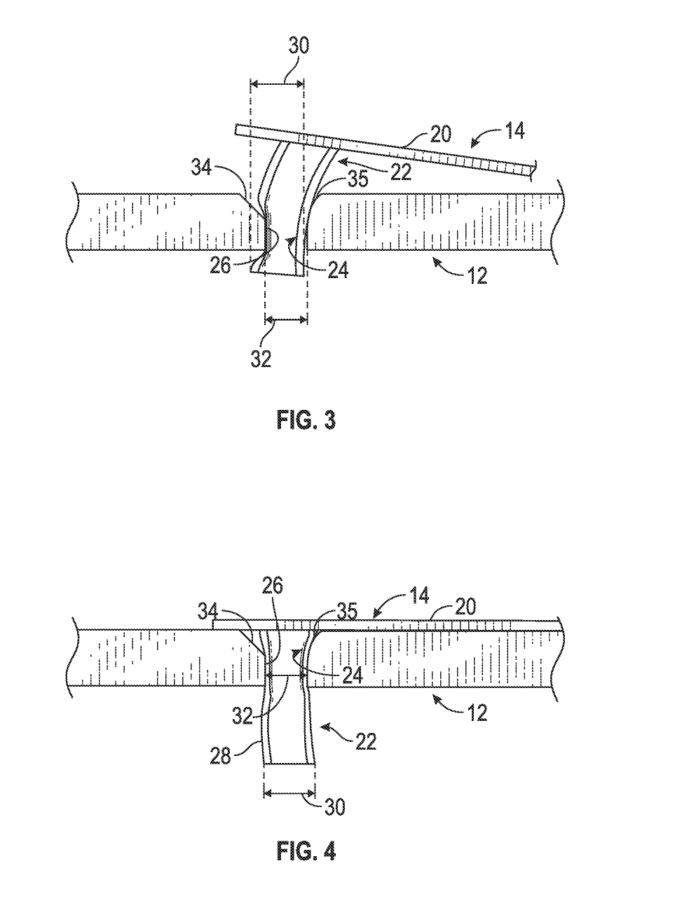

Reference is now made to FIGS. 2-4, which depict details of the second component 14, and more particularly the protrusion 22, in various stages of insertion into the receiving feature 24 (FIG. 2, pre-engaged; FIG. 3, partially engaged; and, FIG. 4, fully engaged).

At the pre-engagement stage, as depicted in FIG. 2, it can be seen that the protrusion dimension 30 is larger than the receiving feature dimension 32, as described above, thereby illustrating that the protrusion 22 will engage the receiving feature walls 26 of the receiving feature 24. Lead-in regions 34, 35 (i.e., angled regions) may be included along a portion of the receiving feature wall 26 to facilitate initial insertion of the protrusion 22. Lead in edge 35 opposite 34 can be angled or arcuate to match tube angle of insertion and ultimately tapers inwardly to establish and define width 32.

At the partially engaged stage, as depicted in FIG. 3, the protrusion 18 is inserted into the receiving feature 24. As described above, the protrusion dimension 30 is larger than the receiving feature dimension 32, thereby causing an interference condition during engagement. The elastically deformable nature of the protrusion 22 facilitates passage through the receiving feature 24 as described herein.

At the fully engaged stage, as depicted in FIG. 4, further insertion of the protrusion 22 into the receiving feature 24 ultimately leads to a fully engaged position of the protrusion 22. In the fully engaged position, a tight, fitted engagement between the protrusion 22 and the receiving feature 24 is achieved by contact interface between at least a portion of the protrusion surface 28 and respective receiving feature walls 26 defining the receiving feature 24, thereby providing a retention force on the mated components. The interference between the protrusion 22 and the receiving feature walls 26 causes elastic deformation of the protrusion surface 28. The malleability of the materials reduces issues associated with positional variance. More particularly, in contrast to a rigid insert that typically results in gaps between the insert and receiving structure at portions around the perimeter of the insert, the protrusion 22 advantageously deforms to maintain alignment of the first component 12 and the second component 14, while also reducing or eliminating gaps associated with manufacturing challenges.

As noted above, the protrusion 22, and thereby the second component 14, is configured to be repeatedly removed from the first component 12 upon the application of a pressure on the protrusion, directly or indirectly, and more specifically from the receiving feature 24. The resilient nature of the elastically deformable material facilitates the repeatability.

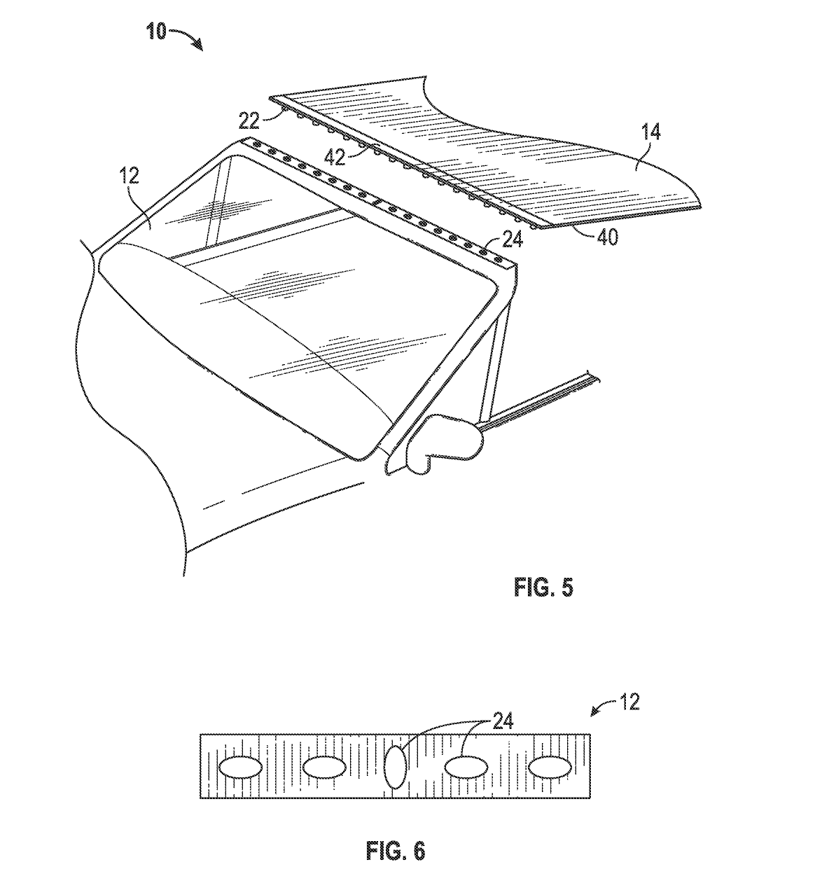

Referring now to FIGS. 5 and 6, the elastically averaged assembly 10 is illustrated according to another embodiment. The embodiment is similar in many respects to the first embodiment, such that similar reference numerals are employed where appropriate and duplicative description of similar elements is not necessary.

In the illustrated embodiment, the first component 12 includes a plurality of receiving features 24 that are arranged in an exemplary receiving feature pattern (FIG. 6), but it is to be appreciated that numerous other patterns would be well-suited for use with the elastically averaged assembly 10. The embodiment relates to the pivotal connection of the second component 14 to the first component 12, but also relates to more generic (e.g., non-pivotal connection) closure arrangements. Therefore, the second embodiment does not require a pivotal connection between the first and second components 12, 14, thereby covering non-pivotal doors and convertible tops, for example. Engagement between the protrusions 22 and the receiving features 24 is made in a similar manner as that described in significant detail above. In the particular non-pivotal embodiment illustrated, the second component 14 may be fixed at an end (not illustrated) in any suitable manner, such as with a hinge, for example, with the bulk of the body of the second component 14 folding in the case of a convertible top. The protrusions 22 are located at a front portion 40 of the second component 14. In one embodiment, the protrusions 22 are fixed along a strip 42 located at the front portion. Each of the protrusions 22 is aligned to engaged corresponding receiving features 24 located on the first component 12, which may be the top of a windshield in the convertible embodiment described above. However, any automotive component benefitting from such an engagement may be used in conjunction with the embodiments described above.

As shown in the embodiment of FIGS. 5 and 6, but also applicable to the embodiment of FIGS. 1 and 2, the first component 12 may include a plurality of receiving features 24 configured to receive a plurality of protrusions 22 of the second component 14. Each of the plurality of receiving features are positioned to correspondingly receive respective protrusions in a manner described in detail above. The elastic deformation of the plurality of elastically deformable protrusions elastically averages any positional errors of the first component 12 and the second component 14. In other words, gaps that would otherwise be present due to positional errors associated with portions or segments of the first component 12 and the second component 14, particularly locating and retaining features, are eliminated by offsetting the gaps with an over-constrained condition of other elastically deformable protrusions. Specifically, the positional variance of each protrusion and/or receiving feature is offset by the remaining protrusions to average in aggregate the positional variance of each protrusion.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, U.S. patent application Ser. No. 13/187,675, now U.S. Publication No. U.S. 2013-0019455, the disclosure of which is incorporated by reference herein in its entirety. The embodiments disclosed above provide the ability to convert an existing component that is not compatible with the above-described elastic averaging principles, or that would be further aided with the inclusion of an elastically averaged alignment and retention system as herein disclosed, to an assembly that does facilitate elastic averaging and the benefits associated therewith.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged assembly for closure applications comprising:
a first component comprising at least one receiving feature; and
a second component to be repeatedly mated with the first component, the second component comprising at least one protrusion, the at least one receiving feature configured to fittingly receive the at least one protrusion, wherein the at least one protrusion is configured to be repeatedly removed from the at least one receiving feature;
wherein the at least one protrusion is formed of an elastically deformable material configured to elastically deform upon contact with the at least one receiving feature.

2. The elastically averaged assembly of claim 1, wherein the at least one protrusion comprises a protrusion dimension greater than a receiving feature dimension, wherein the protrusion and the receiving feature are in a contact interference condition upon engagement of the protrusion and the receiving feature.

3. The elastically averaged assembly of claim 1, wherein the at least one protrusion is disposed proximate an edge of the second component.

4. The elastically averaged assembly of claim 1, wherein the at least one protrusion is configured to be removed from the at least one receiving feature upon the application of pressure on the at least one protrusion.

5. The elastically averaged assembly of claim 1, further comprising a plurality of protrusions and a plurality of receiving features configured to receive the plurality of protrusions.

6. The elastically averaged assembly of claim 5, further comprising a fully engaged position of each of the plurality of protrusions, wherein the fully engaged position comprises contact interference between a protrusion surface of each of the plurality of protrusions and the plurality of receiving features, wherein an amount of deformation of the plurality of protrusions is averaged in aggregate.

7. The elastically averaged assembly of claim 1, wherein the first component and the second component comprise vehicle components.

8. The elastically averaged assembly of claim 7, wherein one of the first component and the second component comprises a convertible top.

9. The elastically averaged assembly of claim 7, wherein one of the first component and the second component comprises a compartment door.

10. An elastically averaged assembly for closure applications comprising:
a mating panel having a receiving feature; and
a closure panel pivotally connected to the mating panel, the closure panel having a protrusion configured to repeatedly engage, and be repeatedly removed from, the receiving feature to provide a closure condition between the mating panel and the closure panel;
wherein the protrusion is formed of an elastically deformable material configured to elastically deform upon contact with the receiving feature.

11. The elastically averaged assembly of claim 10, wherein the protrusion comprises a protrusion dimension greater than a receiving feature dimension, wherein the protrusion and the receiving feature are in a contact interference condition upon engagement of the protrusion and the receiving feature.

12. The elastically averaged assembly of claim 10, wherein the protrusion is configured to be removed from the receiving feature upon the application of pressure on the protrusion.

13. The elastically averaged assembly of claim 10, further comprising a plurality of protrusions and a plurality of receiving features configured to receive the plurality of protrusions.

14. The elastically averaged assembly of claim 13, further comprising a fully engaged position of each of the plurality of protrusions, wherein the fully engaged position comprises contact interference between a protrusion surface of each of the plurality of protrusions and the plurality of receiving features, wherein an amount of deformation of the plurality of protrusions is averaged in aggregate.

15. The elastically averaged assembly of claim 10, wherein the protrusion comprises an arcuate member.

16. The elastically averaged assembly of claim 10, wherein the protrusion comprises a relatively straight member and is aligned substantially perpendicularly to a main portion of the closure panel.

17. The elastically averaged assembly of claim 10, wherein the protrusion comprises a relatively straight member and is aligned in a non-perpendicular arrangement to a main portion of the closure panel.

18. The elastically averaged assembly of claim 10, wherein the first component and the second component comprise vehicle components.

19. The elastically averaged assembly of claim 10, wherein the receiving feature comprises a lead-in region.

20. The elastically averaged assembly of claim 19, wherein the lead-in region comprises an arcuate geometry.
